(19) United States
(12) Patent Application Publication
(10) Pub. No.: US 2023/0341080 A1
(43) Pub. Date: Oct. 26, 2023

(54) Leveling Device

(71) Applicant: Checketts Enterprises, Inc., Clearfieldus, UT (US)

(72) Inventors: Jordan Checketts, Layton, UT (US); Jeffrey Michael Don Kagie, Woods Cross, UT (US); Patrick Brady Auell, Morrison, CO (US)

(21) Appl. No.: 17/660,203

(22) Filed: Apr. 21, 2022

(51) Int. Cl. F16M 11/22

(52) U.S. Cl. CPC F16M 11/22; F16M 2200/08; F24C 1/16

(57) ABSTRACT

Various embodiments of a leveling device are disclosed having a number of innovative features. The leveling device can have a top surface that is upwardly inclined in a lengthwise direction. The top surface can include ridges extending upward to define one or more bounded sections or regions sized to receive and hold a leg or foot of an article that needs to be leveled or stabilized. For example, the leveling device can be placed under the leg of a grill to level the grill surface.

### TECHNICAL FIELD

This relates to leveling devices, especially those used to level or stabilize an article such as a grill.

### BACKGROUND

Barbecue grills are devices that cook food by applying heat from below. One popular type of grill has legs that support the grill on the ground. An example of such a grill is the common gas grill. It has a gas grill surface mounted to a cart that holds propane gas that is burned to create the heat for cooking. The cat includes legs some or all of which can have wheels that make it easy to move the grill from one location to another.

One problem with grills supported on the ground is that the ground is often not level. For example, concrete surfaces positioned next to homes and other structures are often designed to slope away from the structure so that rain and other water that hits the surface will flow away from the structure. Likewise, other types of surfaces such as dirt, gravel, and the like, are also uneven.

Cooking on tilted surfaces is challenging because fat and grease caught in a catch tray underneath the grill will flow to one side or corner of the tray and overflow onto the ground making a mess. Similarly, certain foods such as hot dogs will roll or slide to the low side of the grill.

### GENERAL DESCRIPTION

A leveling device is described that can be used to level and/or stabilize a grill, particularly an outdoor grill such as a gas grill. The leveling device can be positioned between a leg or foot of the grill and the ground or other support surface to level the grill surface.

It should be appreciated that although the leveling device is described primarily in the context of use with a grill, it can also be used to level and/or stabilize a number of other articles. For example, it can be used to level and/or stabilize articles of furniture such as tables, chairs, or the like. The leveling device can be positioned under a leg or foot of the article to level and/or stabilize the article.

In some embodiments, the leveling device can include a top surface that is upwardly inclined in a lengthwise direction. The top surface can include ridges extending in a crosswise direction to form a series of sections configured to receive and hold the end of the leg of a grill or other article. It should be appreciated that the end of the leg can include a wheel, flat hard surface, or the like.

In some embodiments, the leveling device can include a top surface extending upward at an incline. The top surface can include bounded regions size to receive and hold the end of the leg of the grill or other article. The bounded regions can be formed by walls extending upward from the top surface. The walls can be formed by continuous or discontinuous ridges extending upward from the top surface.

In some embodiments, a leveling wedge includes: a first end; a second end positioned opposite the first end in a lengthwise direction of the leveling wedge; a top surface extending upward at an incline from the first end to the second end, the top surface having a flat profile shape; and a bottom surface positioned opposite the top surface, the bottom surface being flat; wherein the top surface includes ridges extending in a crosswise direction of the leveling wedge to form a series of sections sized to receive and hold an end of a leg of a grill.

In some embodiments, the ridges are perpendicular to the lengthwise direction of the leveling wedge. In some embodiments, the leveling wedge includes at least three of the ridges. In some embodiments, the leveling wedge includes at least four of the ridges. In some embodiments, the ridges are first ridges and wherein the top surface includes second ridges extending along each side of the top surface in the lengthwise direction. In some embodiments, the second ridges are parallel to the lengthwise direction of the leveling wedge.

In some embodiments, the leveling wedge is positioned under the leg of the grill. In some embodiments, the ridges in the top surface form at least three sections sized to receive and hold the end of the leg of the grill. In some embodiments, the top surface extends upward at an inclined angle of no more than 10 degrees. In some embodiments, the top surface extends upward at an inclined angle of no more than 7 degrees.

In some embodiments, the top surface includes a texture between the ridges. In some embodiments, the top surface includes projections extending upward to form the texture and wherein the ridges extend upward from the top surface further than the projections. In some embodiments, the ridges extend upward from the top surface at least twice as far as the projections.

In some embodiments, a leveling device includes: a first end; a second end positioned opposite the first end in a lengthwise direction of the leveling device; a top surface extending upward at an incline from the first end to the second end, the top surface having a flat profile shape; and a bottom surface positioned opposite the top surface, the bottom surface being flat; wherein the top surface includes bounded regions sized to receive and hold an end of a leg of a grill.

In some embodiments, the top surface includes at least three bounded regions sized to receive and hold the end of the leg of the grill. In some embodiments, the top surface includes walls extending upward to form the bounded regions. In some embodiments, the walls are formed by discontinuous ridges extending upward from the top surface.

In some embodiments, a grilling system includes: a grill including: a grill surface; legs configured to support the grill surface on a support surface; and a leveling wedge including: a top surface that is upwardly inclined in a lengthwise direction of the leveling wedge, the top surface including ridges extending in a crosswise direction of the leveling wedge to form a series of bounded regions; wherein at least one of the legs of the grill is positioned on the top surface of the leveling wedge. In some embodiments, the top surface is upwardly inclined at an angle of no more than 10 degrees. In some embodiments, the top surface is textured between the ridges.

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### DESCRIPTION OF DRAWINGS

The preferred and other embodiments are described in association with the accompanying drawings in which:

FIG. 1 is a perspective view of one embodiment of a leveling device.

FIG. 2 is a top plan view of the leveling device in FIG. 1.

FIG. 3 is a side elevation view of the leveling device in FIG. 1.

FIG. 4 is a front elevation view of the leveling device in FIG. 1.

FIG. 5 is a cross-sectional side elevation view of the leveling device along the line A-A in FIG. 4.

FIG. 6 is a bottom plan view of the leveling device in FIG. 1.

FIG. 7 is a perspective view of a grilling system with the leveling device being used to level the grill surface of a grill.

### DETAILED DESCRIPTION OF EMBODIMENTS

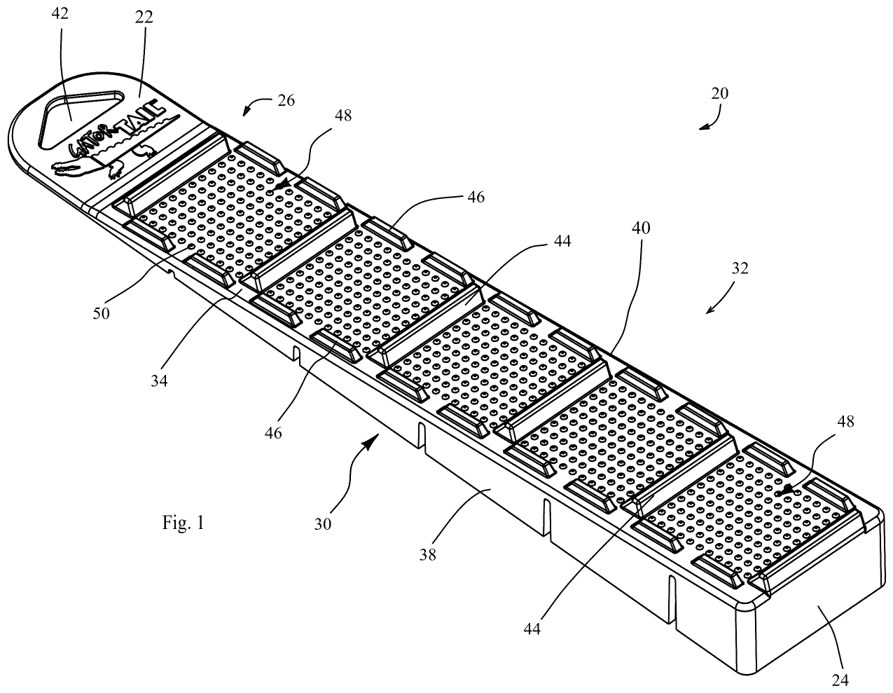

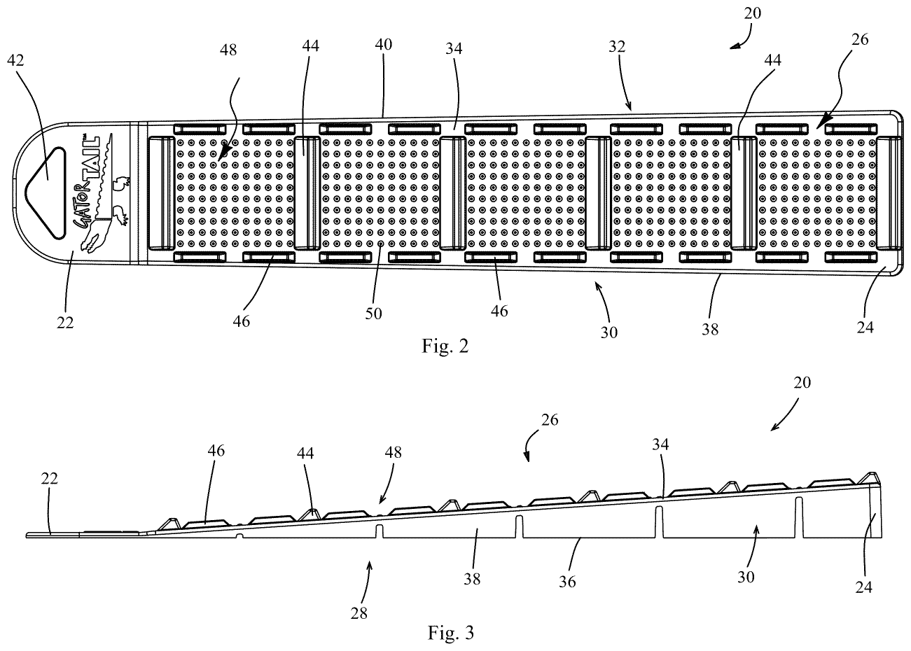

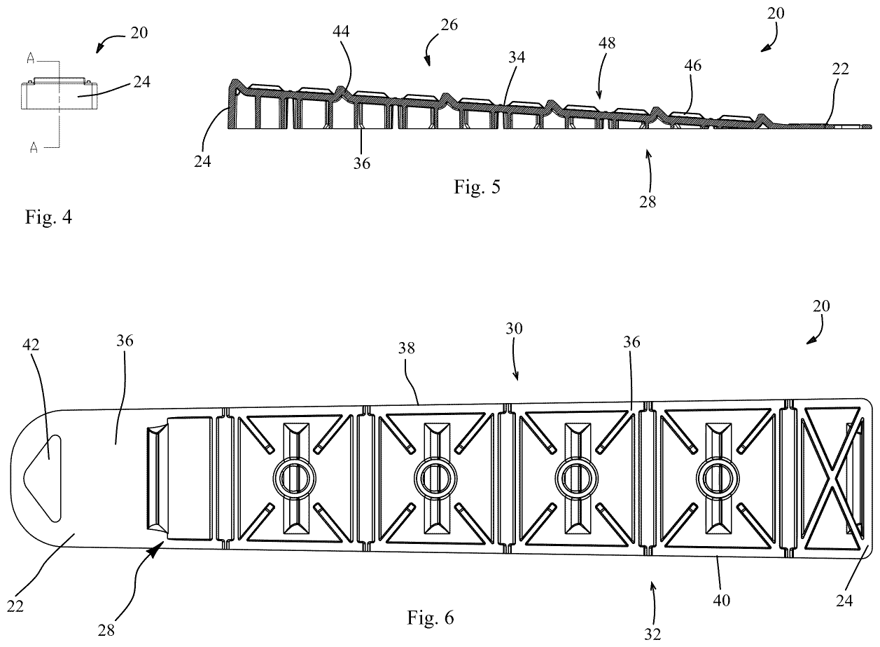

FIGS. 1-6 show one embodiment of a leveling device or leveling wedge 20. The leveling device 20 includes a front or first end 22, a back or second end 24, a top side 26, a bottom side 28, a right side 30, and a left side 32. The first end 22 is positioned opposite the second end 24 along a lengthwise direction of the leveling device 20. The top side 26 is tapered upward from the first end 22 to the second end 24. The right and left sides 30, 32 extend between the top and bottom sides 26, 28.

The top side 26 includes a top surface 34 extending upward at an incline from the first end 22 to the second end 24. The bottom side 28 includes a bottom surface 36 that is flat. The right side 30 includes a right side surface 38 that is flat and extends between the top surface 34 and the bottom surface 36. The left side 32 includes a left side surface 40 that is also flat and extends between the top surface 34 and the bottom surface 36.

The leveling device 20 has a generally elongated shape. The shape can be described as a wedge or being shaped like a wedge. It can also be described as a ramp or being shaped like a ramp. The first end 22 of the leveling device 20 includes a substantially flat portion that is not tapered and has an opening that forms a handle 42. It should be appreciated that the handle 42 can be formed in a variety of alternative ways such as, for example, a grip extending outward from the top surface 34.

The top surface 34 has a generally flat profile shape as seen in FIGS. 3 and 5. It should be noted that describing the top surface 34 as having a flat profile shape does not mean it cannot have projections or other structure extending upward from the top surface 34. Instead, it means that the general overall shape of the profile of the top surface 34 is flat as it extends from the first end 22 to the second end 24 regardless of the presence of projections or other surface features that may be present on the top surface 34.

The top surface 34 can extend upward at any suitable inclined angle relative to the bottom surface 36. In some embodiments, the top surface 34 extends upward at an inclined angle of no more than 10 degrees, no more than 7 degrees, or no more than 5 degrees. In other embodiments, the top surface 34 extends upward at an inclined angle of at least 1 degree, at least 2 degrees, at least 3 degrees, or at least 4 degrees.

The top surface 34 includes first ridges 44 (alternatively referred to as crosswise ridges) and second ridges 46 (alternatively referred to as lengthwise ridges or side ridges). The first ridges 44 project upward from the top surface 34 and extend lengthwise in a crosswise direction of the leveling device 20. The second ridges 46 project upward from the top surface 34 and extend lengthwise in the lengthwise direction of the leveling device 20. The second ridges 46 are generally positioned at the sides of the top surface 34 adjacent to and above the right side and left side surfaces 38, 40.

The ridges 44, 46 are spaced apart to create bounded regions or sections 48 on the top surface 34 of the leveling device 20. The sections 48 are sized to receive and hold the end of the leg of a grill. The first ridges 44 provide periodic boundaries that prevent the leg from sliding downward along the top surface 34 of the leveling device 20. Likewise, the second ridges 46 provide boundaries that prevent the leg from sliding off the sides 30, 32 of the leveling device 20.

The top surface 34 can include any suitable number of sections 48. In some embodiments, the top surface 34 includes at least two sections 48, at least three sections 48, or at least four sections 48.

It should be appreciated that the ridges 44, 46 can be separate distinct ridges as shown in the FIGS. or they can be integrally formed together. In those situations where the ridges 44, 46 are integrally formed together, the portion of each ridge 44, 46 bounding a section 48 is conceptually considered a separate ridge even though the ridges 44, 46 may be one integral piece.

The ridges 44, 46 are shown as forming discontinuous walls that bound the sections 48. This is advantageous because it allows debris and/or water to easily flow out of the sections 48. It should be appreciated, however, that in other embodiments, one or more of the ridges 44, 46 can be configured to form a continuous wall that bounds the sections 48. This can occur, for example, when the ridges 44, 46 are integrally formed together as described above.

The top surface 34 includes projections 50 extending upward in the sections 48 between the ridges 44, 46. The projections 50 form a texture on the top surface 34 in the area between the ridges 44, 46 in the sections 48. The projections 50 have a generally rounded shape and are uniformly spaced apart on the top surface 34.

The projections 50 are generally smaller than the ridges 44, 46. In some embodiments, the ridges 44, 46 extend upward from the top surface 34 at least twice as far as the projections 50, at least three times as far as the projections 50, or at least four times as far as the projections 50.

It should be appreciated that the projections 50 can have any suitable shape and can be positioned in any suitable location to form a texture on the top surface 34. For example, the projections 50 can have a triangular shape, rectangular shape, or the like. Likewise, the projections 50 can be spaced apart in a uniform or irregular manner.

The leveling device 20 can be made of any suitable material. In some embodiments, the leveling device 20 is made of a plastic material. For example, the leveling device 20 can be injection molded using a variety of plastics such as polyolefins or the like. In other embodiments, the leveling device 20 can be made of metal, wood, composites, or the like.

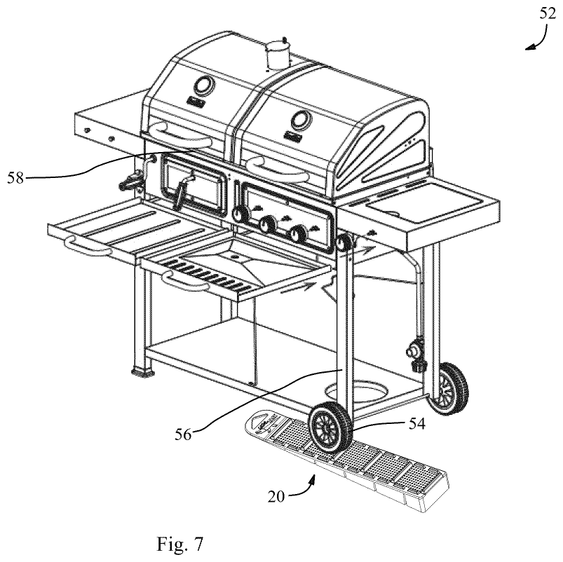

The leveling device 20 can be used in any suitable manner. In some embodiments, the leveling device 20 can be used to level and/or stabilize a gas grill 52 as shown in FIG. 7. In particular, the leveling device 20 can be used to level and/or stabilize a grill surface 58 of the gas grill 52. For example, the leveling device 20 can be positioned underneath the wheel 54 at the end of one leg 56 of the gas grill 52. The leveling device 20 is configured to receive and hold the wheel 54 in one of the sections 48 defined by the ridges 44, 46. The combination of the ridges 44, 46 and the projections 50 hold the wheel 54 in place and prevent movement of the gas grill 52 relative to the leveling device 20.

It should be appreciated that the leveling device 20 can also be used to hold one of the other legs 56 of the gas grill 52 that does not include a wheel. The end of such a leg 56 (alternatively referred to as the foot of the leg) can be received by one of the sections 48 on the leveling device 20.

In some embodiments, multiple leveling devices 20 can be used to level the grill surface 58. For example, one leveling device 20 can be positioned in the manner shown in FIG. 7, and another leveling device 20 can be positioned under another leg 56 of the gas grill 52. This makes it possible to raise both sides of the gas grill 52.

In some embodiments, the gas grill 52 may be positioned on a surface that slopes away from a building such as a home. The use multiple leveling devices 20 makes it possible to raise one side of the gas grill 52 and level the grill surface 58.

General Terminology and Interpretative Conventions

Any methods described in the claims or specification should not be interpreted to require the steps to be performed in a specific order unless expressly stated otherwise. Also, the methods should be interpreted to provide support to perform the recited steps in any order unless expressly stated otherwise.

Certain features described in the context of separate embodiments can also be implemented in combination in a single embodiment. Conversely, various features that are described in the context of a single embodiment can also be implemented in multiple embodiments separately or in any suitable subcombination. Moreover, although features may be described above in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of” or “consisting essentially of”.

Unless otherwise indicated, all numbers or expressions, such as those expressing dimensions, physical characteristics, or the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any subranges or any individual values subsumed by each range. For example, a stated range of 1 to 10 should be considered to include and provide support for claims that recite any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, it is terms such as “processing,” “computing,” “calculating,” “determining,” “displaying,” or the like, refer to the action and processes of an electronic controller including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

Joining or Fastening Terminology and Interpretative Conventions

The term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be further categorized based on the difficulty of releasing the components and/or whether the components are released as part of their ordinary operation and/or use. Readily or easily releasable joining refers to joining that can be readily, easily, and/or promptly released with little or no difficulty or effort. Difficult or hard to release joining refers to joining that is difficult, hard, or arduous to release and/or requires substantial effort to release. The joining can be released or intended to be released as part of the ordinary operation and/or use of the components or only in extraordinary situations and/or circumstances. In the latter case, the joining can be intended to remain joined for a long, indefinite period until the extraordinary circumstances arise.

It should be appreciated that the components can be joined together using any type of fastening method and/or fastener. The fastening method refers to the way the components are joined. A fastener is generally a separate component used in a mechanical fastening method to mechanically join the components together. A list of examples of fastening methods and/or fasteners are given below. The list is divided according to whether the fastening method and/or fastener is generally permanent, readily released, or difficult to release.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pin, linchpins, R-pins, clevis fasteners, cotter pins, latches, hook and loop fasteners (VELCRO), hook and eye fasteners, push pins, clips, clasps, clamps, zip ties, zippers, buttons, buckles, split pin fasteners, and/or conformant fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, or the like can be permanent, readily releasable, or difficult to release depending on the application.

Drawing Related Terminology and Interpretative Conventions

Reference numbers in the drawings and corresponding description refer to identical or similar elements although such numbers may be referenced in the context of different embodiments.

The drawings are intended to illustrate embodiments that are both drawn to scale and/or not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any ranges or subranges that can be formed by such values.

Spatial or directional terms, such as “left,” “right,” “front,” “back,” or the like, relate to the subject matter as it is shown in the drawings and/or how it is commonly oriented during manufacture, use, or the like. However, it is to be understood that the described subject matter may assume various alternative orientations and, accordingly, such terms are not to be considered as limiting.

### INCORPORATION BY REFERENCE

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Additional documents incorporated by reference:—
U.S. Des Pat. application No. 29/792,762, titled “Wedge,” filed on 21 Apr. 2022.

What is claimed is:

1. A leveling wedge comprising:
a first end;
a second end positioned opposite the first end in a lengthwise direction of the leveling wedge;
a top surface extending upward at an incline from the first end to the second end, the top surface having a flat profile shape; and
a bottom surface positioned opposite the top surface, the bottom surface being flat;
wherein the top surface includes ridges extending in a crosswise direction of the leveling wedge to form a series of sections sized to receive and hold an end of a leg of a grill.

2. The leveling wedge of claim 1 wherein the ridges are perpendicular to the lengthwise direction of the leveling wedge.

3. The leveling wedge of claim 1 wherein the leveling wedge includes at least three of the ridges.

4. The leveling wedge of claim 1 wherein the leveling wedge includes at least four of the ridges.

5. The leveling wedge of claim 1 wherein the ridges are first ridges and wherein the top surface includes second ridges extending along each side of the top surface in the lengthwise direction.

6. The leveling wedge of claim 5 wherein the second ridges are parallel to the lengthwise direction of the leveling wedge.

7. The leveling wedge of claim 1 positioned under the leg of the grill.

8. The leveling wedge of claim 1 wherein the ridges in the top surface form at least three sections sized to receive and hold the end of the leg of the grill.

9. The leveling wedge of claim 1 the top surface extends upward at an inclined angle of no more than 10 degrees.

10. The leveling wedge of claim 1 the top surface extends upward at an inclined angle of no more than 7 degrees.

11. The leveling wedge of claim 1 wherein the top surface includes a texture between the ridges.

12. The leveling wedge of claim 11 wherein the top surface includes projections extending upward to form the texture and wherein the ridges extend upward from the top surface further than the projections.

13. The leveling wedge of claim 12 wherein the ridges extend upward from the top surface at least twice as far as the projections.

14. A leveling device comprising:
a first end;
a second end positioned opposite the first end in a lengthwise direction of the leveling device;
a top surface extending upward at an incline from the first end to the second end, the top surface having a flat profile shape; and
a bottom surface positioned opposite the top surface, the bottom surface being flat;
wherein the top surface includes bounded regions sized to receive and hold an end of a leg of a grill.

15. The leveling device of claim 14 wherein the top surface includes at least three bounded regions sized to receive and hold the end of the leg of the grill.

16. The leveling device of claim 14 wherein the top surface includes walls extending upward to form the bounded regions.

17. The leveling device of claim 16 wherein the walls are formed by discontinuous ridges extending upward from the top surface.

18. A grilling system comprising:
a grill comprising:
a grill surface;
legs configured to support the grill surface on a support surface; and
a leveling wedge comprising:
a top surface that is upwardly inclined in a lengthwise direction of the leveling wedge, the top surface including ridges extending in a crosswise direction of the leveling wedge to form a series of bounded regions;
wherein at least one of the legs of the grill is positioned on the top surface of the leveling wedge.

19. The grilling system of claim 18 wherein the top surface is upwardly inclined at an angle of no more than 10 degrees.

20. The grilling system of claim 18 wherein the top surface is textured between the ridges.
